(19) United States
(12) Patent Application Publication
(10) Pub. No.: US 2002/0194033 A1
(43) Pub. Date: Dec. 19, 2002

(54) Automatic insurance data extraction and quote generating system and methods therefor

(76) Inventor: David S. Huff, Berkeley Heights, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/883,439

(22) Filed: Jun. 18, 2001

(51) Int. Cl. G06F 17/60

(52) U.S. Cl. 705/4

(57) ABSTRACT

A method for automatically extracting data and generating insurance quotes includes preparing insurance profiles having risk information for one or more clients seeking insurance coverage, storing the insurance profiles in an electronic database at one or more agency locations, and extracting one or more of the stored insurance profiles from the electronic database. Information from the extracted insurance profiles is translated into a format recognizable by one or more underwriters for risk assessment. The translated information is electronically transmitted to one or more underwriters so that the underwriters can analyze the risk information for determining whether offers of insurance should be made to the clients seeking insurance coverage. The offers of insurance are electronically transmitted to the one or more agency locations in a proposal format presentable to the clients seeking insurance. The entire process requires that data be entered only once, thereby eliminating the time-consuming and error-enabling multiple steps involved in data re-entry at various levels.

### FIELD OF THE INVENTION

The present invention is generally related to the insurance industry and is particularly related to a system and methods for automatically generating insurance quotes and proposals, thereby eliminating the need for redundant data entry.

Insurance companies typically issue insurance policies to individuals, groups and businesses to insure against different types of risk. The paperwork associated with issuing and renewing insurance policies (e.g. application forms) is typically handled by customer service representatives (“CSRs”) working at insurance agencies. As used herein, the term “insurance agency” is used to describe local offices where insurance agents interact with clients. These CSR activities typically require a significant amount of man-hours. For example, a licensed agent may spend many hours interviewing a client to obtain information required for completing an insurance application. A CSR will then enter the information on an application form, and forward the application to one or more underwriters, by mail or facsimile, in order to obtain an insurance quote. The CSR must then follow-up with the one or more underwriters in order to determine the status of the application. Ultimately, the CSR will receive insurance quotes from the one or more underwriters. The CSR must then evaluate the quotes and prepare a proposal for presentation to the client. This procedure, which is repeated many times a day at thousands of agencies across the country, is generally time-consuming and requires identical information to be re-entered many times as the application information passes between the CSR at the agency location and underwriters at the insurance company locations.

FIG. 1 shows a conventional method for obtaining insurance quotes for clients seeking to renew their insurance coverage. At step 20, a CSR physically reviews existing files to identify particular clients or policies that are due for renewal within a predetermined time period. In most insurance agencies, renewal policies are gathered for review approximately 30-120 days prior to the expiration date of the insurance term. Once the files due for renewal are assembled, the CSR or licensed agent must conduct follow-up interviews with clients in order to update the information listed on the application forms that will be sent to the insurance companies or underwriters. At step 22, the CSR prepares the applications by manually entering information onto an application form. This is done by typing the information (1) onto a paper insurance application, (2) into a computerized replica of the application, or (3) into one or more underwriter rating software programs. FIGS. 2A-2B, 3A-3B and 4A-4C show conventional application forms on which information about the potential insured is entered. These forms, which include blocks for receiving specific types of information, may be standardized for a particular industry or type of insurance provided. The forms may also adhere to a particular standard.

FIGS. 2A-2B show an application form for commercial insurance having blocks for receiving general information, including the location of applicant's business, the year the business structure was built, and the portion of the building occupied by the business. FIGS. 3A-3B show a commercial general liability section application form including information blocks for effective date of insurance, expiration date of insurance, and policy coverage limits. FIGS. 4A-4C show a business auto section application form including information blocks for liability limits, and the make and model of automobiles covered by the application.

Once the application forms are completed, printed, and signed by the applicant at step 24, the CSR must transmit the applications to various insurance companies and/or underwriters via mail or facsimile. The activities associated with transmitting the applications require a significant amount of time, because the CSR must send a copy of the application forms to each underwriter or insurance company from which an insurance quote is sought. This may require the CSR to send the application form via facsimile to many different underwriters. In the alternative, the CSR may be required to send copies of the application to different underwriters via regular mail. The CSR may also be required to fill out application forms provided at web sites maintained by underwriters or insurance companies. Another possible CSR activity is the retyping of risk parameters into rating software packages supplied and maintained by underwriters or insurance companies but used within the agency. All of the above activities are unnecessarily duplicative in nature, because they require redundant data entry and thereby increase the cost and time associated with obtaining insurance quotes for new and renewing clients.

At step 26 of FIG. 1, the underwriters review the applications, extract relevant information therefrom, and manually re-enter the information into a risk analysis program so that the underwriter may assess the risks associated with a potential client or a particular type of business or personal coverage sought by the client. This step also significantly increases the time associated with obtaining new or renewal quotes because the information entered by the CSR at the agency location must once again be entered by personnel at an insurance company or underwriter location.

After the application has been sent to the various underwriters, the CSR (Step 28) must follow-up with the various underwriters in order to obtain the status of the application. At the underwriter location, the underwriters review the risk factors revealed by the client's application to determine whether an insurance policy should be issued or renewed. During the follow-up efforts, the CSR spends a significant amount of time waiting for the underwriters to locate and review the relevant file to determine the status of the underwriter analysis process.

At step 30, the CSR receives the quotes from the various underwriters. The quotes generally flow back to the CSR individually over the course of several days or weeks and are not typically received together at the same time. Once the CSR has obtained a sufficient number of quotes, the CSR must extract pertinent information from the quotes (step 32), and re-enter the quote information into computers located at the agency to create a proposal for presentation to a client. At step 34, the CSR presents the proposal to the client. In other embodiments, however, the proposal may be presented to the client by an insurance agent or other individual that normally interacts with clients.

There have been a number of efforts directed to streamlining the insurance quote generating process. U.S. Pat. No. 5,809,478 to Greco et al. discloses a system and method for accessing and evaluating information for processing insurance applications. Greco teaches reducing costs associated with evaluating risk factors for potential insured by improving the speed and accuracy at which insurance policies are processed, and increasing the overall quality of the insurance policies purchased by customers. In one particular embodiment, Greco discloses a method of controlling a computer network that assembles data and renders decisions based on the data. The network includes a main computer having a memory and a data warehouse computer coupled to vendors of proprietary data. The method includes receiving a request to process an application at a main computer, determining whether additional data is needed to process the application, commencing an information interface process to retrieve the needed data through a data warehouse computer, and processing the application with the additional data received through the data warehouse.

U.S. Pat. No. 6,078,890 to Mangin et al. discloses a method and system for automated health care rate renewal and quality assessment. The method includes utilizing an electronic request package having embedded formulas adapted to perform calculations and macros suited to the information needs of individual providers. The data is automatically compiled and stored in a database using a data extraction tool integrated into the electronic request package. The method allows evaluation of a portfolio of managed care providers for price and quality, and facilitates integration of data updates and modifications for potential providers.

Another effort directed to reducing the workload on CSRs when obtaining insurance quotes is provided by Transformation Station, a joint venture with IVANS using WARP technology developed by Applied Systems, a software vendor to the insurance industry. Transformation Station provides relief for some of the problems discussed above since there is a transfer of risk parameters that eliminates data entry; however, the CSR must still do a significant amount of work to place the application in a form specified by the insurance underwriter. Specifically, Transformation Station requires that all fields of the application form be completed, including entering complex coding derived from manuals. In addition, the CSR will be required to provide information requested by many different underwriters, even if the CSR is seeking only a single quote from a single underwriter. In addition, the transfer of data to the underwriter is not automatic, but must be initiated by the CSR. In practice, the error correcting process for Transformation Station is so complicated that few CSR's will be able to successfully complete the data transmission process.

Another quote generating system, called WebSEMCI, has many of the same problems found in Transformation Station. Another process, commonly used by aggregators on the Internet requires the CSR to type the applicant information into the aggregator's web page. The information entered into the web page by the CSR is then sent to many different insurance companies or underwriters. When using this process, however, the CSR must take data from previously prepared applications and re-enter the information onto the aggregators' web pages at their web sites.

In spite of the above advances, there remains a need for an automated quote generating and proposal system that does not require the agency or underwriting personnel to retype or re-enter data into an application form each time a quote is sought from a different underwriter. Such an improved system should automatically extract information from previously prepared client profiles so that the risk parameters can be provided to underwriters without requiring additional work by CSRs. Such an improved system should also automatically enrich the data with additional information, when necessary, and interpret that data so that the information required by the underwriters can be translated into a format useable by the respective underwriters.

### SUMMARY OF THE INVENTION

In accordance with certain preferred embodiments of the present invention, a method for automatically extracting data and generating insurance quotes includes preparing insurance profiles having risk information for one or more clients seeking insurance coverage, and storing the insurance profiles in an electronic format at one or more agency locations. The insurance profiles may be stored in an electronic database, such as a database in communication with a server, hard drive or memory. The insurance profiles desirably include specific risk data as well as information about the type of insurance or the levels of insurance sought by the one or more clients seeking insurance coverage. When one or more quotes are desired, the stored insurance profiles are preferably extracted from the electronic database, and the extracted insurance profiles are electronically transmitted to one or more underwriters in a format recognizable by the underwriters. The insurance profiles may be extracted automatically, without user intervention, or may be extracted in response to action taken by the CSR. Upon receiving the risk information, the underwriters, without the need for manually re-entering risk parameters, can analyze the risk information in the insurance profiles for determining whether offers of insurance should be made to the one or more clients seeking insurance coverage. If the underwriters conclude that one or more offers should be issued, the offers of insurance, including coverage terms and pricing, are electronically transmitted to the one or more agency locations in a finished proposal format presentable to the one or more clients seeking insurance. The information sent from the underwriters to the agency location(s) does not have to be re-entered by CSRs at the agency location(s).

In certain preferred embodiments, the extracting step may include enriching the data in the insurance profiles, such as by adding information obtained from third-party databases. The extracting step may also include interpreting the insurance profile to verify that all necessary information has been compiled and to confirm that industry-standard terminology is being used. The method may also include updating information in one or more of the insurance profiles stored in the electronic database at the agency location. The updating information step may occur at scheduled intervals, periodically, or when desired by a CSR, agent, underwriter, or any other individual involved in the insurance industry.

The extracting step may include identifying insurance policies that are scheduled to expire within a specified time period and retrieving the insurance profiles associated with the identified insurance policies. In certain preferred embodiments, the extracting step includes identifying at least one client and retrieving the insurance profile(s) associated with the at least one identified client. The extracting step may also include identifying one or more types of insurance and retrieving the insurance profiles of the clients associated with the one or more types of insurance identified. In still other embodiments, the extracting step may include extracting profiles for insurance written by particular insurance carriers or types of insurance carriers, regardless of renewal date. The extracted insurance profiles may also be grouped by type of insurance coverage sought by the one or more clients.

After the insurance profiles are extracted, the profiles may be electronically transmitted to a central computer that desirably includes a universal translator. The central computer preferably translates the information from the extracted insurance profiles into a format readable by the one or more underwriters. The extracted insurance profiles are electronically transmitted to the central computer in one or more formats. The central computer may include a processor capable of retrieving information from the insurance profiles and translating the information into a format readable by the underwriters.

In performing the data enrichment function, the central computer is preferably in communication with one or more proprietary databases for obtaining additional information needed by the underwriter computers to allow for a determination of whether offers of insurance should be made to the one or more clients seeking insurance coverage.

As used herein, the terminology “interpretation”means that the central computer compares the data terminology in the insurance profiles, with standardized terminology used by one or more underwriter computers. If standard terminology is not present in the profile, the central computer re-formats the data into a format recognizable and/or useable by one or more underwriter computers. The central computer may also be adapted to insert previously agreed-upon default information in fields where required information may be missing.

In certain preferred embodiments, each underwriter desirably has one or more computers in communication with the central computer capable of receiving the extracted profiles for enabling the underwriter to evaluate the risk information associated with the extracted profiles. The central computer preferably translates the information associated with the extracted profiles into a format useable by the underwriters. The various formats may be selected from the group consisting of a printed format and a digital format. Preferred formats include ASCII, XML, HTML, AL3 and other electronic formats.

If the underwriter decides to issue an insurance quote, the quote is preferably electronically transmitted back to the agency computer through the central computer. While passing through the central computer, the quote may be reformatted by the central computer into a finished proposal for use by the respective agency computers. Thus, the offers of insurance may be electronically transmitted to an insurance agent or CSR at the agency location, without the need for the CSR or agent to further customize the information contained in the quote. The format is desirably selected from the group consisting of a printed format and a digital format. Preferred digital formats include ASCII, delimited, XML, HTML, AL3 and other electronic formats.

In other preferred embodiments, a method for automatically generating insurance quotes includes compiling insurance profiles on one or more clients seeking insurance coverage, wherein each insurance profile includes risk information associated with each of the one or more clients, storing the insurance profiles including the risk information in an electronic database, selectively retrieving the risk information associated with one or more of the stored insurance profiles and electronically transmitting the risk information to one or more underwriter computers adapted to analyze the risk data so that underwriters may determine whether offers of insurance should be made to the one or more clients seeking insurance.

In still other preferred embodiments of the present invention, a system for generating insurance quotes includes one or more computers for creating and storing insurance profiles for one or more clients seeking insurance coverage, the one or more computers being in communication with an electronic database for storing the created insurance profiles, and one or more underwriter computers in communication with the agency computer for receiving one of the one or more insurance profiles, analyzing the received insurance profiles for assessing risk associated with the one or more clients seeking insurance coverage, determining whether offers of insurance should be made to the one or more clients seeking insurance coverage, and electronically transmitting the offers of insurance to the agency computers. The system also desirably includes a central computer in bi-directional communication with both the agency computers and the underwriter computers for translating the insurance profiles into a format usable by the underwriter computers and the agency computers. In still other embodiments, the extracted profiles can be used to automatically produce loss runs or request loss runs or other information needed by the CSR, regardless of whether the request is from the client, underwriter or other party.

The central computer desirably translates offers of insurance from the underwriter computers into a format usable by the agency computers for generating insurance proposals for one or more clients seeking insurance.

The agency computers preferably utilize software applications selected from the group consisting typically of TAM, AfW, Sagitta, AMS Prime, DORIS, Agency Works, VRC, Instar, Ebix CD1 and Ebix CD2. The central computer may include a bi-directional universal translation protocol that translates formats in the group consisting of ASCII, delimited, XML, HTML, AL3 and other electronic formats. The types of insurance selected may include any type of insurance such as workers' compensation, businessowners' policies, umbrella, property, general liability, automobile, homeowners', boat-owners', inland marine, health, life, and disability policies. The agency computers may be located at agencies and wholesalers, and may include a visual display adapted to present one or more profile screens and a data entry device for creating insurance profiles on one or more clients seeking insurance coverage. The underwriter computers may be located at underwriters, managing general agencies, managing general underwriters, insurance companies, carriers and wholesalers. The system may also include wholesaler computers in communication with the agency computers and the central computer, wherein the wholesaler computers aggregate insurance profile information from one or more agency central computers for transmission to the central computer.

The system may also be configured where the extraction commands are contained at the central computer, commonly known as an Application Service Provider (ASP”). Using this embodiment of the present invention, the central computer, during its communication with the agency computer, will specify extraction commands, receive the risk parameters, and return requests for more information, declination letters or completed proposals.

### BRIEF DESCRIPTION OF THE DRAWINGS

FIG. 1 shows a conventional method for obtaining insurance quotes.

FIGS. 2A-2B show application forms constituting the general information section of a commercial insurance application.

FIGS. 3A-3B show application forms constituting the commercial general liability section of a commercial insurance application.

FIGS. 4A-4C show application forms constituting the business auto section of a commercial insurance application.

FIG. 5 shows a system for automatically extracting data and generating insurance quotes, in accordance with certain preferred embodiments of the present invention.

FIGS. 6A-6C show a flow chart detailing the steps for automatically extracting data and generating insurance quotes, in accordance with certain preferred embodiments of the present invention.

FIG. 6B-1 shows a directory name for an insurance profile, in accordance with certain preferred embodiments of the present invention.

FIG. 7 shows a schematic drawing for automatically extracting data and generating insurance quotes in accordance with another preferred embodiment of the present invention.

FIG. 8 shows a schematic drawing detailing a system for automatically extracting data and generating insurance quotes in accordance with still further preferred embodiments of the present invention.

### DETAILED DESCRIPTION OF PREFERRED EMBODIMENTS

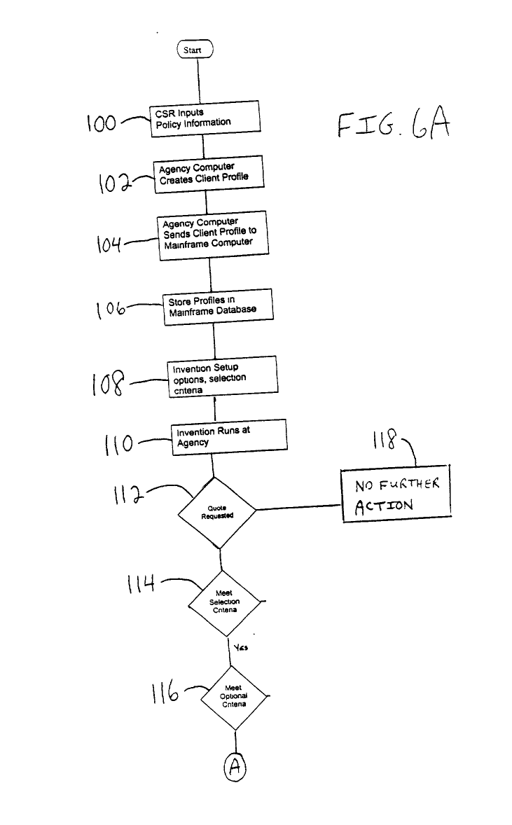

Referring to FIG. 5, in certain preferred embodiments of the present invention, a system 50 for automatically generating insurance quotes includes a first agency location 52 and a second agency location 54. As used herein, the terms “insurance quote,” “offer of insurance,” “insurance” and “proposal” are used interchangeably to describe an offer for insurance. Although FIG. 5 shows only two agency locations, preferred embodiments of the present invention may include an infinite number of agency locations around the world. As used herein, the term “agency” preferably includes independent insurance agencies, agencies affiliated with a particular insurance carrier, managing general agencies (“MGA”) and insurance wholesalers.

The first agency location 52 includes a first computer 55 having a video monitor 56 and a desktop processing unit 58 electronically interconnected with the video monitor 56. The first agency location 52 also includes a second computer unit 60 having a video monitor 62 and a desktop processing unit 64 electronically interconnected therewith. As used herein, the term “computer” is defined to mean computers networked together, personal computers, laptop or notebook computers, hand-held computers, personal digital assistants (“PDAs”), Internet computers, Internet devices or appliances, mini-computers or larger computers, including mainframe computers, and their equivalents.

The first and second computers 55, 60 are connected via a local area network (LAN) 66 to a server 68 having a memory 70. The second agency location 54 also has a local area network (LAN) 76 interconnecting a first computer 70, a second computer 72, and a third computer 74 with a server 78 having a memory 80. The servers 68, 78 are in communication with central computer 82. The agency level servers 68, 78 may transmit and receive communications via a number of different technologies including the Internet, telephone line and radio wave.

The system 50 also preferably includes a central computer 82 including at least one computer monitor 84 and desktop processing unit 86 connected to central computer 82. The central computer 82 preferably includes a plurality of programs and databases including but not limited to programs stored within a memory device for receiving and processing the queries transmitted from the agency computers to the central computers electronically. In certain preferred embodiments, the electronic transmission occurs through electronic e-mail transmitted from the agency located computer system using a number of commercially available e-mail packages, proprietary e-mail systems or the like. Other forms of electronic transmission can be used, however, such as File Transfer Protocol (“FTP”) or Internet Transfer Protocol (“TCP/IP”) or others.

Central computer 82 is also in communication with one or more third party databases 88 that are selectively accessed for obtaining supplemental information about one or more clients seeking to obtain insurance quotes. One such third party database includes a database that provides information about businesses such as SIC code, employee count, sales. Other business information may include classification codes and/or experience modification data for workers' compensation, classification data for general liability policies, property information such as protection class, building construction, and other such data. One preferred database may be the Dun & Bradstreet database. The present invention aggregates the risk parameters extracted from the respective policies maintained at the agency location. In one embodiment, the extracted policies include those that are scheduled for renewal within a common time period. The risk parameters from the extracted policies are then electronically transmitted in bulk to the central computer rather than being transmitted individually. In one preferred embodiment of the present invention, the risk parameters are extracted automatically without the CSR initiating either the extraction or the data transmission. The communications link between the agency computers and the central computer may preferably be a telecommunications link to an Internet service provider (“ISP”) which gives the agency connectivity to the Internet. In certain preferred embodiments, a software program at the central computer translates the risk data and the insurance profile into a format used by rating modules operated by the underwriters to allow the underwriter to evaluate the risk and to automatically generate insurance quotes for new and/or renewal business. While each agency may use a different ISP, and some agencies may use the same ISP, the ISP preferably includes a mail-handling program having functional communication with the central computer, which translates the e-mails originating from the respective agency computers into a format recognizable by underwriter computers in order to allow risk evaluation. Depending upon the insurance carriers or underwriters evaluating the risk information, the central computer may perform initial risk screening so that the risk information is sent to the locations of the respective carriers or underwriters only if it fits certain pre-described risk parameters established by the underwriters. The quotations generated by the underwriter computers are then sent back to the central computer, formatted into a finished proposal and forwarded to the one or more agencies for presentation to clients. Thus, the communication links shown in the drawings are bi-directional, electronically transmitting information from agency computers to a central computer, to underwriter computers, and back again to the agency computers.

The system 50 also preferably includes one or more underwriter locations, including first underwriter location 90, second underwriter location 92 and third underwriter location 94. As used herein, the term underwriter location is defined broadly to cover entities that rate and assess risks in conjunction with generating quotes for insurance coverage. The term “underwriters” also includes entities such as insurance companies, insurance carriers, insurance wholesalers, managing general underwriters, managing general agencies, and underwriters. Although each underwriter location 90, 92, 94 shows only a single computer terminal and desktop processing unit, each underwriting location may include a plurality of interconnected computers or servers interconnected via local area networks or wide area networks. As will be described in more detail below, each underwriter location is designed to receive one or more insurance profiles on one or more clients seeking insurance. Conventional risk assessment programs at the underwriter locations 90, 92, 94 are preferably used to analyze the risks associated with potential clients or types of business to determine whether offers of insurance should be made to the potential clients.

In operation, a CSR at first agency location 52 creates individualized profiles on potential clients seeking insurance coverage, or current insureds seeking renewal coverage. As used herein, the term “client” and “insureds” may be used interchangeably to define natural persons, corporations, partnerships, businesses, organizations such as non-profit organizations, institutions and the like. In certain preferred embodiments, a licensed agent preferably interviews a potential or current client so as to obtain information regarding the type and levels of insurance desired. The licensed agent will ask a wide range of questions so that underwriters may accurately evaluate potential risk. The information obtained by the licensed agent is input into computers 55, 60, by the CSR whereby unique insurance profiles are created for each potential client based on the information collected by the licensed agent. The unique profile will include information such as the location of an individual's residence or business, the size of the individual's facility, the value of its assets, the cost of goods sold, type of vehicles insured, and/or information about employee population that may be used in life or health underwriting. As the unique insurance profiles are created, the profile information is stored in the memory device 70 of server 68. similarly unique insurance profiles are also generated at second agency location 54 and stored in server 78. As noted above, system 50 may include dozens, hundreds, thousands or an infinite number of other agency locations that are not depicted in FIG. 5. Each of these agency locations will desirably include a local computer having a memory for storing the updated insurance profile, a server having a memory for storing and updating insurance profiles or connected to an Application Service Provider, such as AfW Online or TAMCentral, having a memory for storing updated insurance profiles. AfW Online is a service offered by Agency Management Systems Services, Inc., located in Windsor, Conn. TAMCEntral is a service offered by Applied Systems located in University Park, Ill.

At each agency location, the agency may use a proprietary software package for collecting, organizing and storing profile information on potential insureds. Some of the proprietary packages include TAM, AfW, Sagitta, AMS Prime, DORIS, Ebix CD1 and Ebix CD2. The various proprietary software packages for storing profile information may not interface with one another, or with the software maintained at the underwriter locations 90, 92, and 94. The present invention overcomes this particular problem by providing a central computer 82 with specialized software or protocols that are able to transform the unique profiles obtained from the various agency locations into a format usable by the various underwriter locations 90, 92, and 94. In other words, the central computer 82 serves as a universal translator for translating insurance profiles of potential clients into a format usable by various underwriters. This translation includes (1) interpreting the data to validate standardized insurance industry terminology and (2) enriching the data by supplementing it with third-party information obtained at database 88 and/or by inserting previously agreed-upon default information in those fields if such required information is missing. After the profiles have been translated and reformatted into a usable format, the profile information is forwarded to the underwriters via communication devices such as the Internet or telephone line. After the personnel and/or software programs at the underwriter locations have determined whether or not offers of insurance should be made, the offers or rejections are directed back to central computer 82. Upon receiving the quotes from the underwriter locations, the central computer 82 interfaces with the agency locations 52, 54 to provide proposals including insurance quotes that are presentable to potential clients.

In certain preferred embodiments, software programs located within agency computers query one or more linked databases for compiling a listing of those insurance policies due to expire within a specified time period. In one particular preferred embodiment, the preferred period is ninety (90) days from the date of the query, although other time periods, ranging from approximately 30 to approximately 120 days, may also be used. The actual length of the time period selected depends upon the needs of the agency, clients and particularly the needs of the industry. The agency located computers are desirably programmed to perform the queries on a daily basis, although less frequent intervals, such as, but not limited to, every other day, weekly, twice monthly, may also be established using program software installed on agency located computers. The time of day that the queries are generated may also be controlled so that the query activity occurs during off-business hours when there is little or no use of the agency computer system, thereby eliminating overload of the agency computer system by operators. As a result, the timing of the queries may be scheduled so as to have a minimal impact on the availability and/or operating efficiency of the agency computer systems. The central computer performs a translating function to convert all incoming and outgoing electronic transmissions from whatever format they may be when received to whatever format is required by the device interfacing with the central computer. Preferred formats for translation include ASCII, delimited, XML, HTML, AL3, or other web-based e-mail or electronic formats.

In certain preferred embodiments, if the underwriter declines to offer a quotation because the risk information falls outside desired parameters for issuing a new or renewal policy, the quote generating process is terminated. An indication is transmitted to the central computer which generates a letter of ineligibility to be forwarded to the requesting client. The letter of ineligibility is transmitted electronically from the central computer to the agency computer, and then to the client.

If the underwriter decides that the requesting client is eligible for a policy, a quotation or renewal proposal is generated and forwarded to the central computer. The program software within the central computer preferably translates the information received from the underwriters and prepares a customized finished proposal for presentation to the potential or current client. The proposal is then forwarded to the agency representing a particular client. In another preferred embodiment, the proposal is prepared by agency computers after receipt of the quote from the central computer. Using techniques available to one of ordinary skill in the art, the proposal to the client can be further customized or tailored to satisfy the specific needs of a particular agency. In certain preferred embodiments, information from the agencies such as conditions affecting the quotation of a premium, and instructions for obtaining a binder for the renewing insurance policy can be added to the proposal by the agencies. Other data that may appear within a proposal preferably includes start and termination dates for the renewed policy, identification of the insured, limits of coverage and applicable endorsements, a listing of how premium payments are allocated for the various insurance coverages, information regarding claims reporting, loss control, premium auditing, invoicing and financing options, a copy of the insurance application, information on the agency's commission, and other information that the agency may wish to include with a new business or renewal proposal.

Although the present invention is not limited by any particular theory of operation, it is believed that the automatic data extraction and quote generating system 50 of the present invention annually saves hundreds of man-hours per agency normally required by conventional data gathering quote-generating methods that require the same information to be entered and re-entered many times in order to obtain insurance quotes and generate client proposals. In preferred embodiments of the present invention, information to create a unique client profile is entered only once. The need to enter the same information two or more times is unnecessary in view of central computer 82, which is capable of translating the profiles received from the various agencies into a format useable by the various underwriters. Thus, central computer 82 serves as a bi-directional, universal translator that is able to format and reformat information as necessary in order to automatically generate insurance quotes and transfer information back and forth between agencies and underwriters. Moreover, central computer 82 is able to generate proposals for presentation to clients that may be forwarded electronically via e-mail. As discussed above, conventional methods require CSRs to manually extract relevant information from quotes received from underwriters, and to then insert the relevant information into individualized proposals that are presentable to clients.

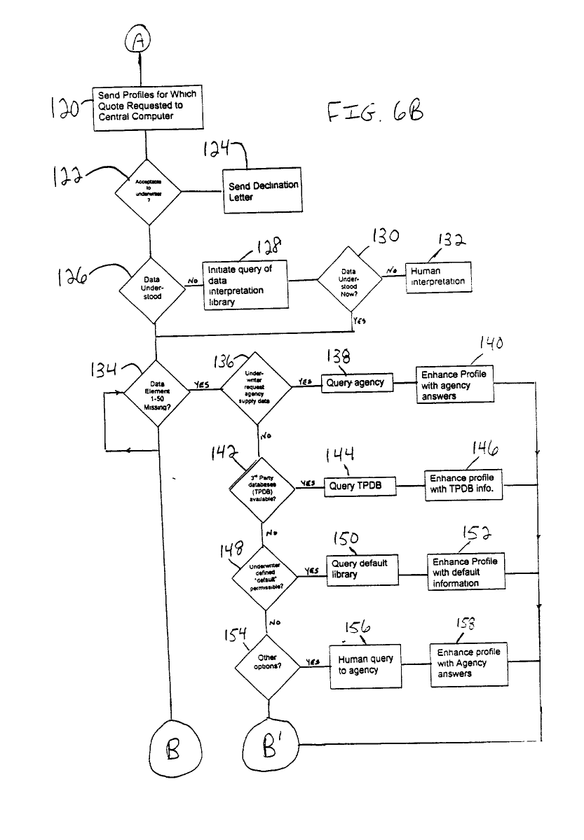

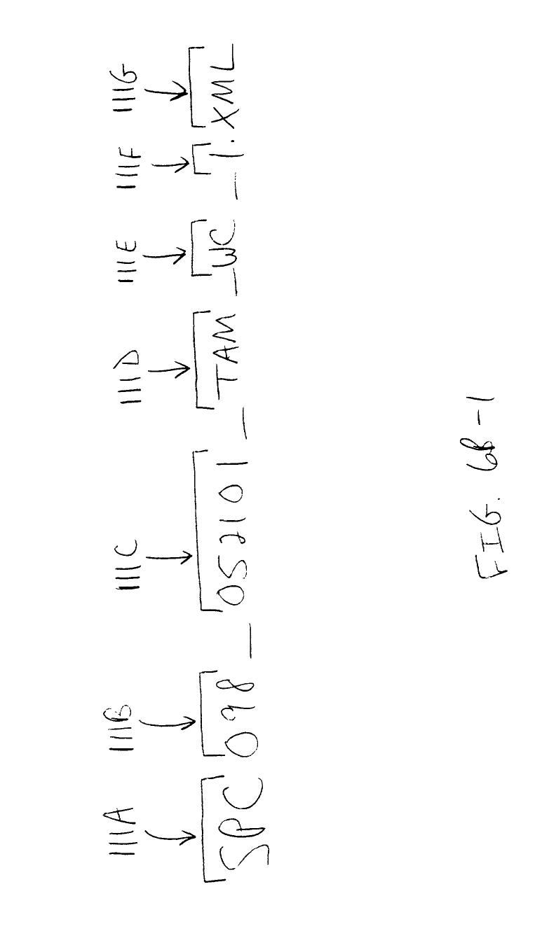

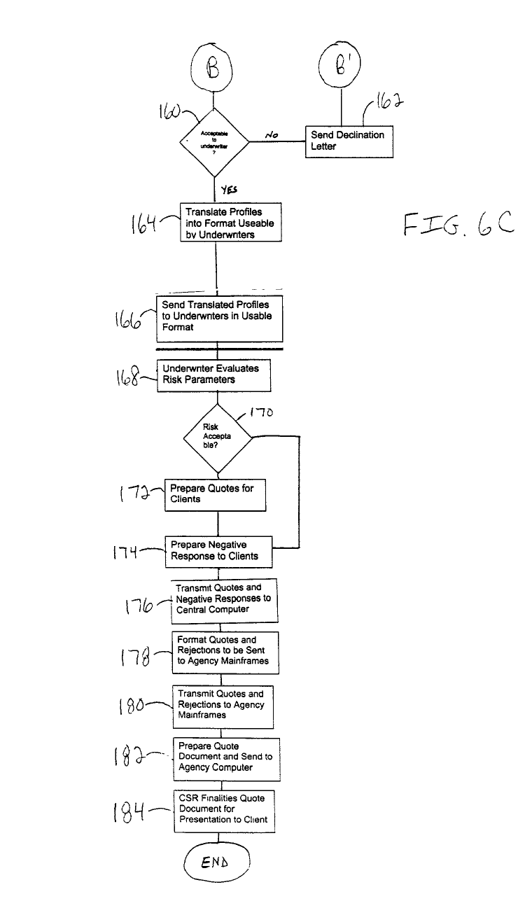

FIGS. 6A-6C show a method of automatically extracting data and generating insurance quotes, in accordance with other preferred embodiments of the present invention. Referring to FIG. 6A, the licensed agent interviews a potential client seeking insurance and the CSR inputs risk parameters into a program at step 100 to create a unique insurance profile. The agency computer creates a unique client profile at step 102 and sends the profile to its mainframe computer or server at step 104. The one or more profiles created for the one or more potential or current clients are stored in a memory device or database located in the agency's mainframe computer or server at step 106. At step 108, the agency sets up the options and selection criteria, choosing how often the system runs, lines of business included, whether the agency needs to manually review clients selected, and other such criteria. At step 110, the system operates based on the setup options and selection criteria activated. Step 110 preferably includes accessing insurance profiles by the designated agency computer. At step 112, the designated agency computer determines whether a quote has been requested and, at step 114, determines whether certain types of selection criteria are met such as line of business, expiration date, particular underwriter/carrier, etc. If a quote is not requested at step 112, or no criteria are selected at step 114, no further action is taken. On the other hand, if a quote is requested for any or all of a client's policies, policy types, or other selection criteria, then other optional criteria, such as deleting client name(s) for purposes of confidentiality, may be applied at step 116. Referring to FIG. 6B, the profile(s) are then forwarded electronically to a central computer at step 120.

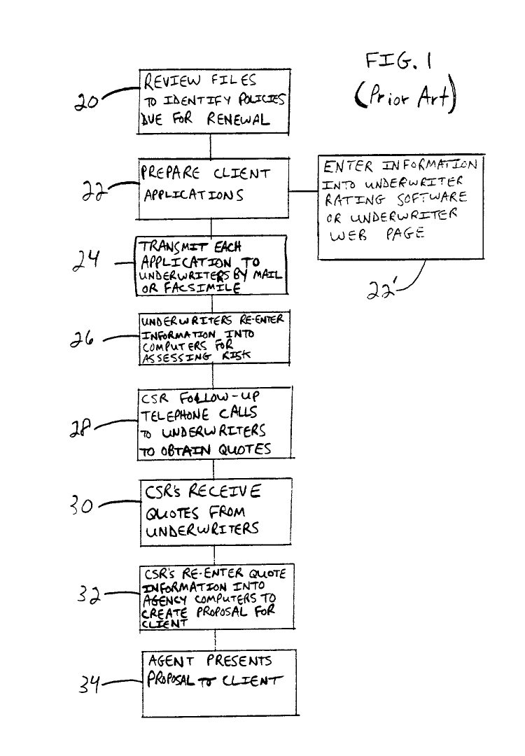

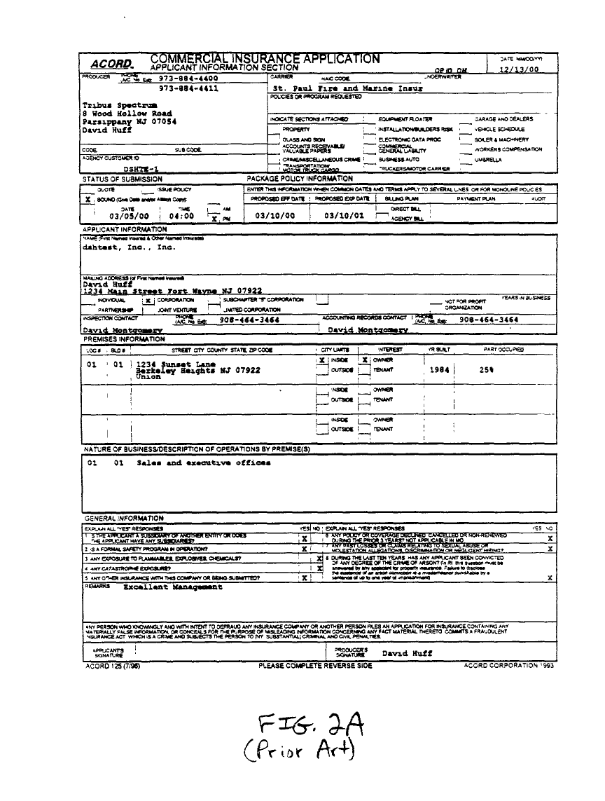

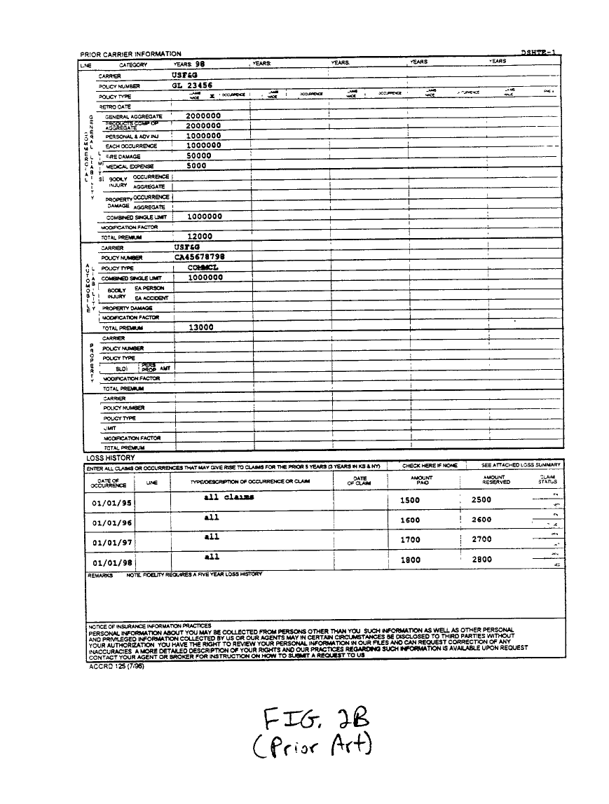

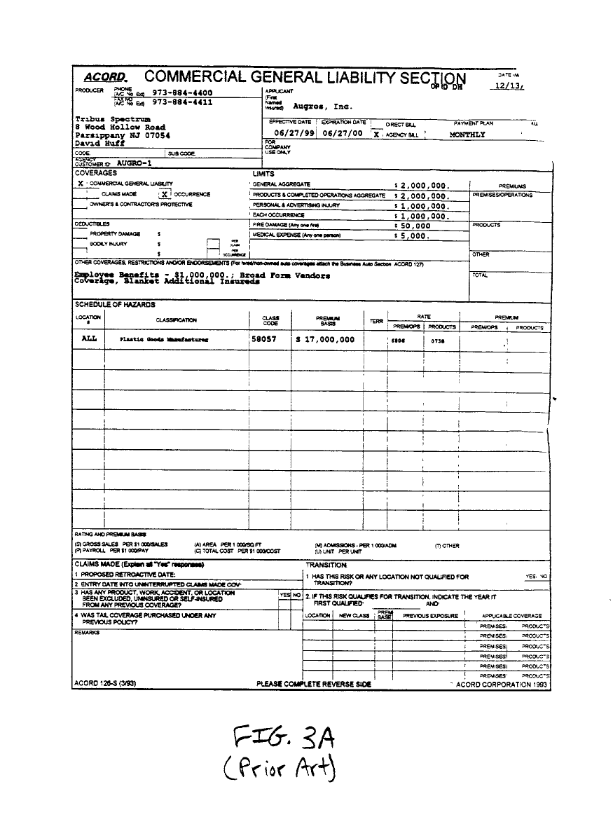

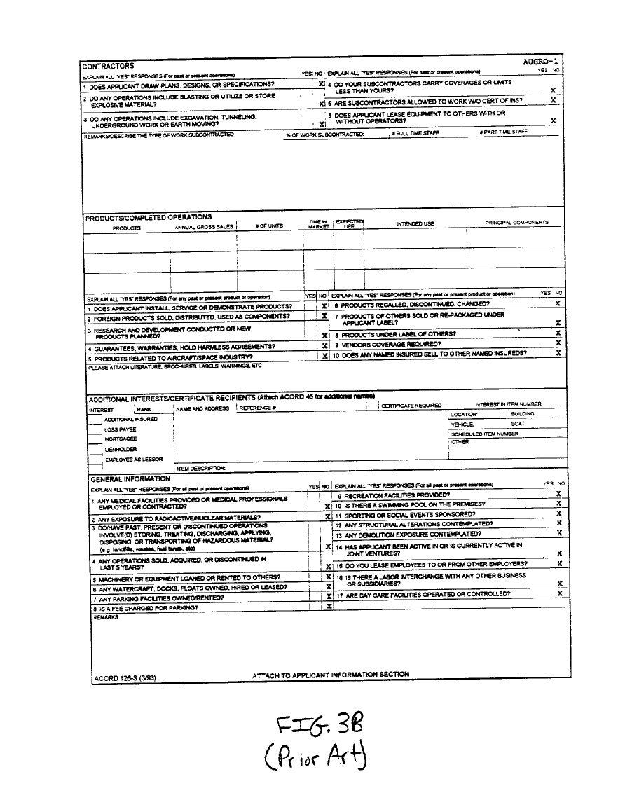

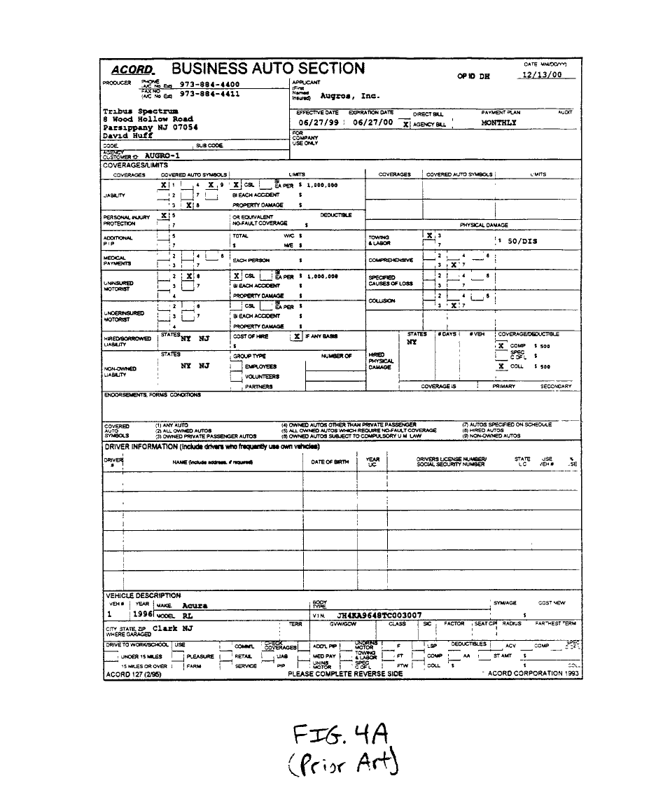

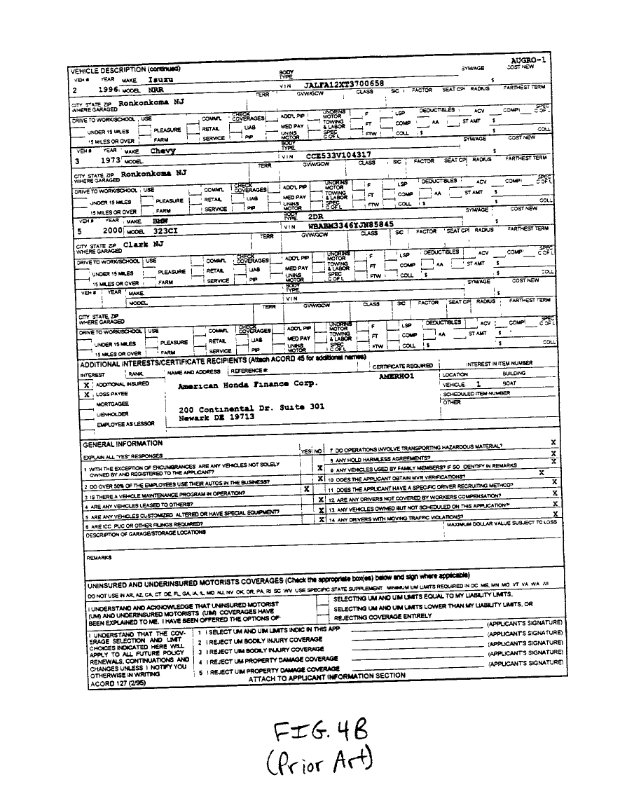

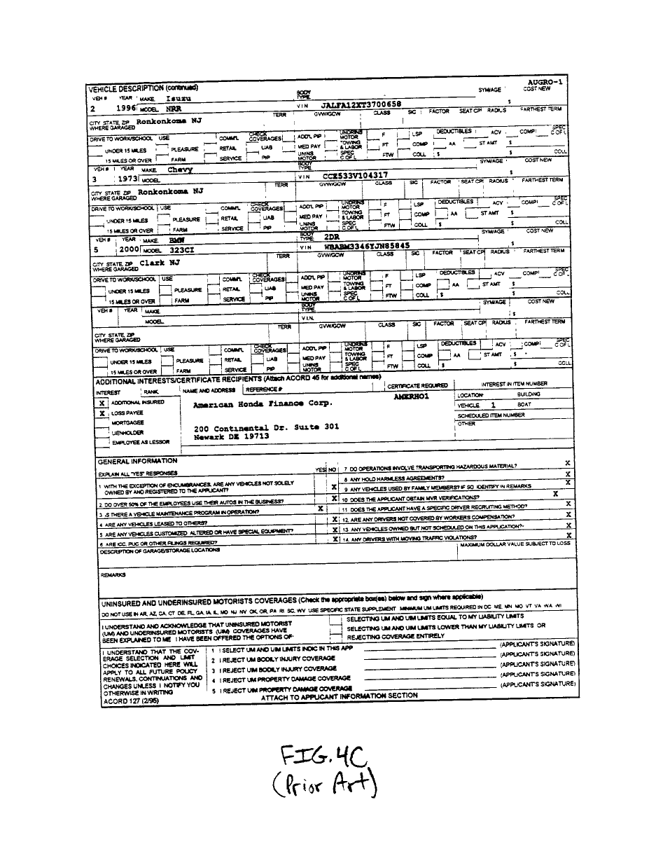

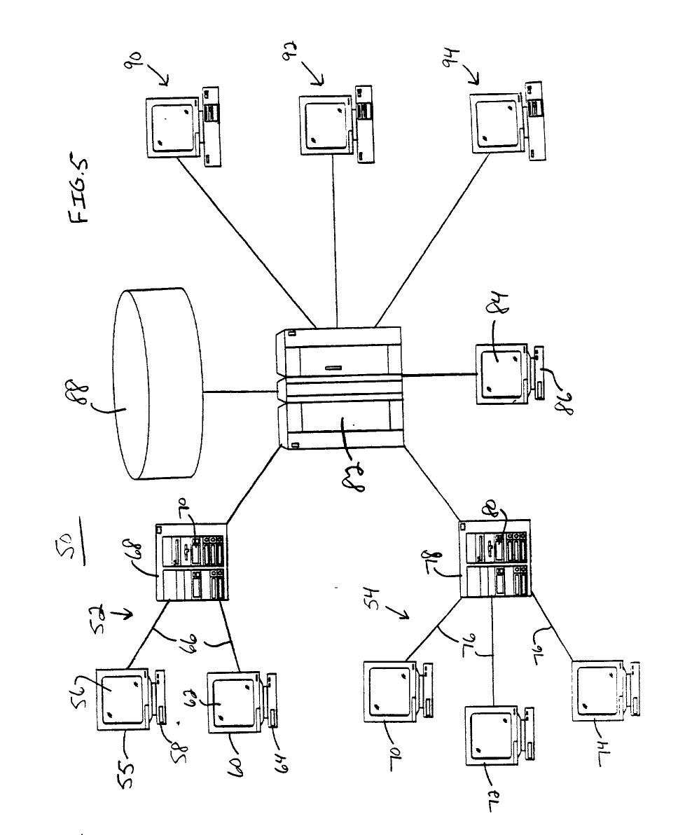

Referring to FIG. 6B-1, a file name for an insurance profile may be used by the central computer to obtain information about the insurance profile. The information may be used when the insurance profile is translated for various underwriters. The file name shown in FIG. 6B-1 includes at least seven different code segments designated 111A-111G. The first code segment 111A designates the intended destination or underwriter that will receive the insurance profile. In the particular embodiment shown in FIG. 6B-1, the destination for the insurance profile is represented by the abbreviation SPC, for St. Paul Insurance Company. The second segment 111B of the file name indicates the agency, assigned agency no. 98, from which the insurance profile originated. The third segment 111C of the file name indicates the date upon which the insurance profile was extracted from the agency computer. The fourth segment 111D of the file name indicates the automation system utilized by the agency computer, for maintaining the insurance profiles, such as TAM, an abbreviation for The Agency Management program. The fifth segment 111E of the file name indicates the type of insurance coverage sought, such as WC for Workmen's Compensation. The sixth segment 111F indicates the extraction order of the insurance profile. In the file name shown in FIG. 6B-1, the number one (1) is associated with the insurance profile, indicating that the extraction is the first extraction of the day from the agency designated 098. The seventh segment 111G of the file designates the language format used by the agency computer, such as the XML language format. The central computer preferably utilizes the seven segments of the file name to translate the extracted insurance profile into a format useable by the respective underwriters. Other preferred embodiments may include file names having more or less segments. For the file name shown in FIG. 6B-1, the information must be translated into a language format useable by St. Paul Insurance Company. The format language used by St. Paul may be different than XML, thereby requiring the profile to be placed into a different format such as ASCII. The central computer may also use the file name to prescreen the particular insurance profiles sent to underwriters. For example, the St. Paul Insurance Company may not desire to write workmen's compensation policies. As a result, the insurance profile associated with the file name shown in FIG. 6B-1 will not be forwarded to the St. Paul Insurance Company, but only insurance companies seeking to write workmen's compensation policies.

If any of the extracted insurance profiles do not meet any of the underwriters' guidelines at step 122, then a declination letter is sent to the agency at step 124. If the central computer does not understand any of the data information at step 126, it will query the interpretation library at step 128 to compare the information submitted with certain stored standardized terminology. If the interpretation function fails and the information is still not understood at Step 130, then human interpretation at step 132 is required to resolve the inconsistency and enhance the interpretation library. At step 134, the central computer determines if all the necessary data elements are in place. Necessary data elements may include items such as construction, protection class, tax town, building rate, deductible, property coverage limit and other such information. If any of the profiles are missing data elements, then it is determined at step 136 whether the agency is required to supply the missing information. If so, the agency is queried at step 138 for the missing data and if the agency responds with the needed facts at step 140, the profiles are enriched with that data at step 140. If the agency does not respond, then the central computer will determine, at step 142, whether there are any accessible third-party databases (TPDB's) which might contain the missing information. If so, then those TPDB's are queried at step 144 and the profiles enriched with the information at Step 146. If the information is not available in any TPDB, then the central computer determines, at step 148, whether an underwriter-defined default can be used in place of the actual information. If so, then the default library is queried at step 150 and the profiles are enriched with the default information at step 152. If not, then the central computer must determine at step 154 whether the risk can be submitted to underwriters without the information.

Referring to FIG. 6C, if the insured's profile meets the initial risk selection criteria, the central computer translates the enriched information in the insured's profile into a format usable by a particular underwriter at step 164. In other words, the central computer interfaces with each particular underwriter so as to determine the particular format under which that underwriter's software program operates, and translates the information from the insurance profile into a format usable by that underwriter. As a result of this translation, and possible enrichment, the underwriter is provided with all of the information needed to accurately assess client risk and to determine whether to issue an offer of insurance.

Referring to FIG. 6C, the translated profile information is sent to underwriters in a format usable by the underwriters at step 166. At step 168, the profile information is analyzed and evaluated to determine whether an offer of insurance should be made. If the risk is deemed acceptable at step 170, the underwriter generates instructions directing that an insurance quote be prepared for the potential client at step 172. If the risk is unacceptable, the underwriter rejects the application for insurance coverage or increases its cost based upon the risk information at step 174. At step 176, the quotes from the underwriter location and the rejections are sent back to the central computer. In one particular preferred embodiment, the central computer will translate the quote and/or rejection information into a format communicated to CSRs at agency locations. The central computer preferably formats the quote and/or rejection information at step 178 into a finished proposal that may be fine-tuned by the agency computers for presentation directly to a potential insured or an insured seeking to renew an insurance policy.

Referring to FIG. 6C, at step 180 the central computer electronically transmits the quotes and/or rejections to the agency computers. At step 182, the server and computers at the agency prepare formal quote proposal documents, if not already prepared by central computer, that may be presented to clients. At step 184, the CSR finalizes the proposal documents for presentation to clients, which may include printing the proposal documents using a printer attached to one of the agency level computers.

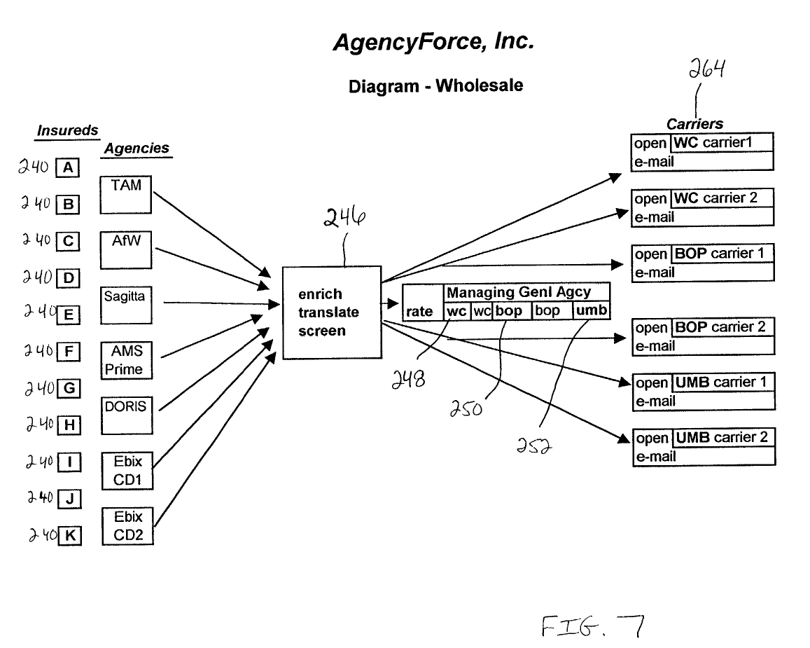

FIG. 7 shows a schematic diagram of a system for automatically extracting data and generating insurance quotes, in accordance with certain preferred embodiments of the present invention. As shown in FIG. 7, potential insureds designated 240A-240K interact with various insurance agencies designated 242A-242G. The software program used by first agency 242A is commonly referred to as The Agency Manager TAM (“TAM”), a registered trademark of Applied Systems located in University Park, Ill. TAM is a multi-functional software program developed for use by insurance brokers and insurance agencies.

The software program utilized by the second agency 242B is AfW, a software program that employs structured query language (“SQL”) server technology. The AfW software program is provided by Agency Management Systems Services, Inc., located in Windsor, Conn.

The software program utilized by the third agency 242C is the Sagitta program, also provided by Agency Management Systems Services, Inc. and is designed to be used by larger insurance agencies.

The software program utilized at the fourth agency 242D is a program similar to AfW, but is generally used for smaller insurance agencies.

The software program utilized by the fifth insurance agency 242E is the Dependable Organized Reliable Insurance System (“DORIS”) designed to operate at an agency location. The DORIS program includes functions such as automated accounting, daily connection to an insurance company computer system, as well as other elements of the insurance business. DORIS is provided by Dependable Organized Reliable Insurance Systems, Inc. located in Alpharetta, Ga.

The software program utilized at the sixth insurance agency 242F utilizes an Ebix Internet-based insurance exchange. The Ebix CD1 program is provided at the URL www.ebix.com. The seventh insurance agency 242G uses another Internet-based insurance exchange, Ebix CD2. Insurance profiles from all agencies 242G are forwarded directly to a central computer 246A where the profiles are analyzed to classify the various types of insurance sought by the potential insureds. Some of the preferred types of insurance include workers' compensation policies 248, businessowners' policies 250 and umbrella policies 252. After the policy types have been classified, central computer 246 electronically transmits the particular policies sought to underwriters or insurance carriers 254, such as by using the Internet or e-mail. Before the information is sent to the underwriters, the information is translated (interpreted, enriched, and re-formatted) by central computer 246 into a form usable by the respective underwriters. Upon receiving the request for various types of insurance as well as the unique user profiles, the underwriters 254 will analyze the risk factors associated with each request, and make a decision regarding whether to generate an insurance quote. If a carrier 254 decides to generate one or more insurance quotes, the quotes are preferably electronically retransmitted back to central computer 246, and then to the respective agencies 242A, 242G. At the central computer 246, the insurance quotes from the respective underwriters or carriers are retransmitted back to the agencies in a format usable at the respective agency levels. Upon receiving the quotes at the agency level, the CSRs located at the respective agencies will prepare proposals to be presented to insureds 240A-240K if such proposals have not already been prepared by central computer 246.

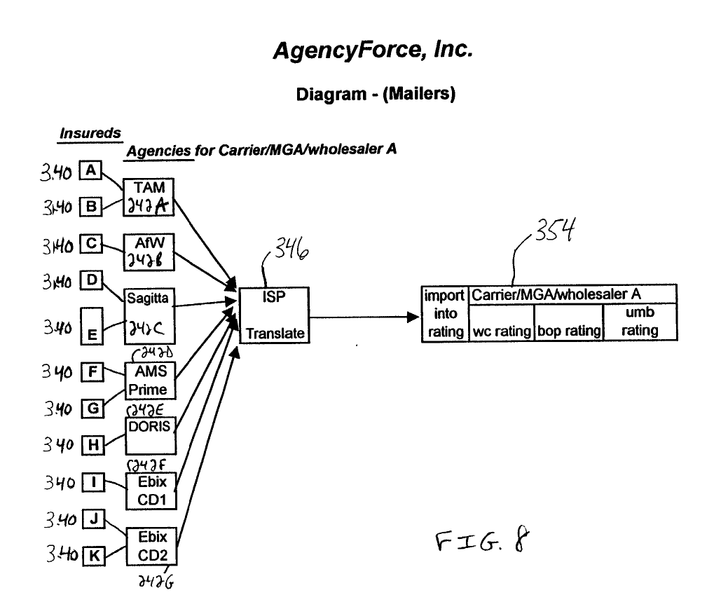

FIG. 8 shows still another preferred embodiment of the present invention including a system for automatically extracting data and generating insurance quotes. The system includes potential insureds 340A-340K that interact with CSRs at agencies 342A-342G. At the agency level, the CSRs receive information from potential insureds regarding various risk factors and/or types and levels of insurance coverage sought. The collected information is then utilized to generate unique insurance profiles on each potential insured. The profile information is forwarded to a central computer 346 that translates the information into a format usable by carrier 354. The carrier 354 has personnel or application protocols that analyze the various risks associated with the request for insurance in order to determine whether an insurance quote should be issued. The decision is electronically transmitted back to central computer 346, and then on to the respective agencies 342A-342G for presentation to potential insureds 340A-340K.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims

What is claimed is:

1. A method for automatically generating insurance quotes comprising:
preparing insurance profiles including information for one or more clients seeking insurance coverage;
storing the insurance profiles in an electronic database at one or more agency locations;
extracting one or more of the stored insurance profiles from said electronic database;
translating the extracted insurance profiles into a format recognizable by one or more underwriters; and
electronically transmitting said insurance profiles to said underwriters, wherein said underwriters analyze the information in said insurance profiles for determining whether offers of insurance should be made to said one or more clients seeking insurance coverage.

2. The method as claimed in claim 1, further comprising electronically transmitting the offers of insurance to the one or more agency locations in a proposal format presentable to the one or more clients seeking insurance.

3. The method as claimed in claim 1, wherein the translating step includes conforming said information to standard terminology used in the insurance industry.

4. The method as claimed in claim 1, wherein the translating step includes supplementing the information with additional information.

5. The method as claimed in claim 4, wherein the supplementing step includes accessing one or more third-party databases for obtaining the additional information.

6. The method as claimed in claim 1, wherein the translating step includes pre-screening said insurance profiles before the step of electronically transmitting said insurance profiles to said underwriters.

7. The method as claimed in claim 6, wherein the extracting step includes compiling a group of said insurance profiles, and wherein at least one of said insurance profiles are removed from said group during the pre-screening step.

8. The method as claimed in claim 1, wherein each said insurance profile includes information about types of insurance sought by said one or more clients seeking insurance coverage.

9. The method as claimed in claim 1, wherein each said insurance profile includes client data and information about levels of insurance sought by said one or more clients seeking insurance coverage.

10. The method as claimed in claim 1, wherein the extracting step occurs automatically without human intervention.

11. The method as claimed in claim 10, wherein the extracting step occurs periodically.

12. The method as claimed in claim 10, wherein the extracting step occurs at scheduled intervals.

13. The method as claimed in claim 10, wherein the extracting step occurs selectively and in response to human intervention.

14. The method as claimed in claim 1, wherein the extracting step includes identifying insurance policies that are scheduled to expire within a specified time period and retrieving the insurance profiles associated with the identified insurance policies.

15. The method as claimed in claim 1, wherein the extracting step includes identifying at least one of the one or more clients and retrieving the insurance profiles associated with the identified clients.

16. The method as claimed in claim 1, wherein the extracting step includes identifying one or more types of insurance and retrieving the insurance profiles of the clients associated with the one or more types of insurance identified.

17. The method as claimed in claim 1, wherein the extracting step includes grouping the extracted insurance profiles by type of insurance coverage sought by the one or more clients.

18. The method as claimed in claim 1, wherein the extracting step includes grouping the extracted insurance profiles by name of carrier.

19. The method as claimed in claim 1, further comprising electronically transmitting the extracted insurance profiles to a central computer adapted to interface with the one or more underwriters, wherein said central computer is adapted to perform the translating step.

20. The method as claimed in claim 19, wherein the extracted insurance profiles are electronically transmitted to the central computer in one or more formats, said central computer including a processor capable of retrieving information from said insurance profiles and providing the information into a format readable by said underwriters.

21. The method as claimed in claim 1, wherein each said underwriter has one or more computers in communication with said central computer for receiving the extracted profiles so as to allow said underwriters to evaluate the risk information associated with the extracted insurance profiles.

22. The method as claimed in claim 19, wherein said central computer translates the information associated with the extracted profiles into a format useable by said underwriters for assessing risks associated with the one or more clients seeking insurance coverage.

23. The method as claimed in claim 1, wherein the proposal format presentable to the one or more clients seeking insurance is a format selected from the group consisting of a printed format and a digital format.

24. The method as claimed in claim 1, wherein said format is selected from the group consisting of ASCII, delimited, XML, HTML, AL3 and other electronic formats.

25. The method as claimed in claim 23, wherein the step of electronically transmitting the offers of insurance includes transmitting the offers of insurance to an insurance agent or customer service representative (CSR) at the agency location, the method further comprising customizing one or more of the offers of insurance into a proposal having a format readable by at least one of the one or more clients.

26. A system for generating insurance quotes comprising:
one or more agency computers for creating and storing insurance profiles for one or more clients seeking insurance coverage, wherein said one or more computers are in communication with an electronic database for storing the created insurance profiles;
one or more underwriter computers in communication with said one or more agency computers for receiving one or more of the insurance profiles, analyzing the received insurance profiles for assessing risk parameters associated with the one or more clients seeking insurance coverage, determining whether offers of insurance should be made to the one or more clients seeking insurance coverage, and electronically transmitting the offers of insurance to the agency computers; and
a central computer in bi-directional communication with both said agency computers and said underwriter computers for translating said insurance profiles into a format usable by said underwriter computers and said agency computers.

27. The system as claimed in claim 26, wherein said central computer translates offers of insurance from said underwriter computers into a format usable by said agency computers for creating or modifying insurance proposals for the one or more clients seeking insurance.

28. The system as claimed in claim 26, wherein said central computer is in communication with one or more proprietary databases for obtaining additional information used by said underwriter computers for determining whether offers of insurance should be made to the one or more clients seeking insurance coverage.

29. The system as claimed in claim 26, wherein said agency computers utilize software applications selected from the group consisting typically of TAM, AfW, Sagitta, AMS Prime, DORIS, Agency Works, VRC, Instar, Ebix CD1 and Ebix CD2 and others.

30. The system as claimed in claim 26, wherein said central computer includes a bi-directional universal translation protocol that translates formats in the group consisting of ASCII, delimited, XML, HTML, AL3 and other electronic formats.

31. The system as claimed in claim 26, wherein said types of insurance are selected from the group consisting of workers' compensation, businessowner's policies, property, general liability, auto, inland marine, umbrella and various personal lines policies.

32. The system as claimed in claim 26, wherein said agency computers are located at agencies and wholesalers.

33. The system as claimed in claim 26, wherein said underwriter computers are located at underwriters, managing general agencies, managing general underwriters, insurance companies, carriers and wholesalers.

34. The system as claimed in claim 26, wherein said agency computers include a visual display adapted to present one or more profile screens and a data entry device for creating insurance profiles on one or more clients seeking insurance coverage.
